(19) United States
(12) Patent Application Publication
(10) Pub. No.: US 2025/0272154 A1
(43) Pub. Date: Aug. 28, 2025

(54) Method and System for Gradually Altering Compute Resources Allocated to Workloads in a Cloud Computing Environment

(71) Applicant: International Business Machines Corporation, Armonk, NY (US)

(72) Inventor: Matthew Paul Jarvis, Burlington, MA (US)

(21) Appl. No.: 18/588,190

(22) Filed: Feb. 27, 2024

(51) Int. Cl. G06F 9/50

(52) U.S. Cl. CPC G06F 9/505; G06F 2209/5019

(57) ABSTRACT

A computer implemented method, system and product for gradually altering compute resources allocated to workloads in a cloud computing environment is described. A fixed percentage per increment is determined by which to alter a current allocation of at least one of a set of compute resources allocated to at least one of a set of workloads in a cloud computing environment during a selected period of time to incrementally switch the current allocation of the at least one of the set of compute resources allocated to the at least one of the set of workloads in the cloud computing environment from an original allocation to a target allocation. The current allocation is switched incrementally by the fixed percentage per increment the current allocation from the original allocation to the target allocation during the selected period of time.

### BACKGROUND

The disclosure relates generally to managing computer resources and more specifically to altering computer resources such as CPU and/or memory allocated to workloads in a cloud computing environment.

In a cloud computing environment where workloads are competing for a fixed set of resources (CPU/memory), it is common to impose resource limits on workloads in order to achieve predictable performance. Without these limitations, one workload could consume more than its “fair share” of resources and cause performance problems for other workloads in the system.

Over time, administrators may need to alter these resource limits, allocating more or less CPU/memory to a particular workload, or imposing limits that were previously not enforced. Making a change to resource limits can be risky and can potentially impact the performance and stability of all workloads in the system, especially when reducing the resources that are allocated to a process.

Therefore, it would be desirable to have a computer implemented method, a computer system, and a computer program product that take into account at least some of the computer resource management issues discussed above, as well as other possible issues.

### SUMMARY

According to an illustrative embodiment, a computer implemented method gradually alters computer resources, such as CPU limit and/or memory limit, allocated to workloads in a cloud computing environment by a constant percentage of resource change instead of integer unit of resource change. In order to mitigate the risk of making a change to resource limits, especially a drastic change, administrators can roll out changes to resource limits gradually and monitor the overall impact to the performance and stability of the system. When considering the potential performance impact of a resource limit change, it is much more important to consider percentage of the change rather than integer units of measure change. For instance, reducing the CPU allocation for a process from 2 CPUs to 1 CPU (50% reduction) will have a much larger performance impact than reducing from 16 CPUs to 15 CPUs (6.25% reduction). The larger percentage reduction incurs more risk although both involve a change of 1 integer unit of measure change. According to other illustrative embodiments, a computer system, and a computer program product gradually alter computer resources, for example CPU and/or memory limits, allocated to workloads in a cloud computing environment by percentage of change instead of integer unit of measure change.

Embodiments of this disclosure alter allocated resources by a consistent percentage over time, thereby minimizing the risk that the changes will introduce instability in the system. Consider the scenario where a cloud computing administrator is imposing resource limits on a workload running on a host with 16 CPUs. The administrator would ultimately like to limit the workload to 1 CPU core, but imposing that limit change all at once risks introducing performance and stability problems with that workload. The administrator decides to roll out the changes gradually over 15 days while monitoring the system. A naive approach would be to reduce resources linearly over the 15 days, reducing the CPU allocation by 1 core per day. A problem with this approach is that the percentage change in the CPU allocation keeps increasing over the rollout window. From day 0 to day 1, there is just a 6.25% drop in CPU capacity (16 cores to 15 cores) . . . but from day 14 to day 15, there is a 50% drop (2 cores to 1 core). The change on day 15 is much riskier than the change on day 1. Embodiments of this disclosure can use a calculation to reduce the CPU allocation by the same percentage each day, evenly spreading out the risk over the rollout window. In the scenario above, this would result in roughly a 16% reduction in CPU capacity each day over the 15 days.

### BRIEF DESCRIPTION OF THE DRAWINGS

FIG. 1 is a block diagram of a computing environment in accordance with an illustrative embodiment;

FIG. 2 is a block diagram of a computer system for gradually altering compute resources allocated to workloads in a cloud computing environment in accordance with an illustrative embodiment;

FIG. 3 is a dataflow diagram for gradually altering compute resources allocated to workloads in a cloud computing environment in accordance with an illustrative embodiment;

FIG. 4 is a flowchart of a process for gradually altering compute resources allocated to workloads in a cloud computing environment, comprising: determining, by a number of processors, a fixed percentage per increment by which to alter a current allocation of at least one of a set of compute resources allocated to at least one of a set of workloads in the cloud computing environment during a selected period of time to incrementally switch the current allocation of the at least one of the set of compute resources allocated to the at least one of the set of workloads in the cloud computing environment from an original allocation to a target allocation; and switching, by the number of processors, incrementally by the fixed percentage per increment the current allocation from the original allocation to the target allocation during the selected period of time in accordance with an illustrative embodiment;

FIG. 5 is a flowchart of a process for determining the fixed percentage where a roll out window includes the selected period of time in accordance with an illustrative embodiment;

FIG. 6 is a flowchart of a process for determining the fixed percentage where switching incrementally by the fixed percentage per increment defines a plurality of discrete notch steps in accordance with an illustrative embodiment;

FIG. 7 is a flowchart of a process for determining the fixed percentage where switching is performed at substantially constant time intervals in accordance with an illustrative embodiment;

FIG. 8 is a flowchart of a process for determining the fixed percentage where the fixed percentage is defined by r=ln(target allocation)−ln(original allocation) where r is the fixed percentage, ln(target allocation) is a natural logarithm of the target allocation, and ln(original allocation) is a natural logarithm of the original allocation in accordance with an illustrative embodiment; and

FIG. 9 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

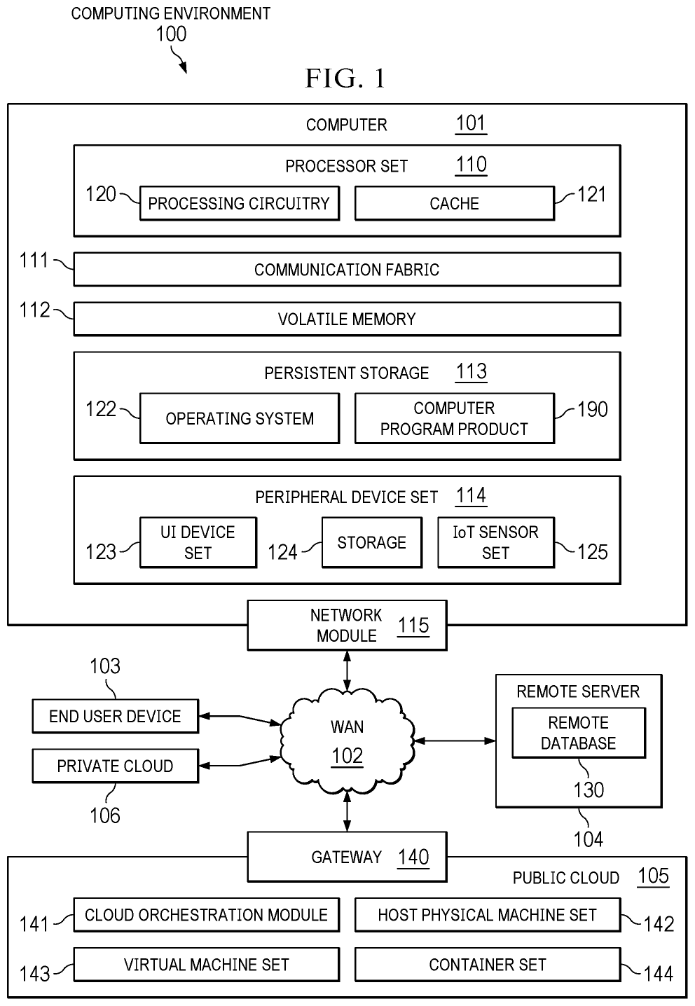

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as predicting, using an artificial intelligence enabled system, an incremental degradation of a battery of a transportation vehicle, calculating an equivalent carbon footprint, calculating an equivalent carbon footprint tax, and assessing the tax against the vehicle. Embodiments of this disclosure can be embodied in block 190. In addition to block 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Block 190 is a generic representation of a computer program product for gradually altering compute resources allocated to workloads in a cloud computing environment. Block 190 can also monitor the overall impact to the performance and stability of the system resulting from these changes to resource limits.

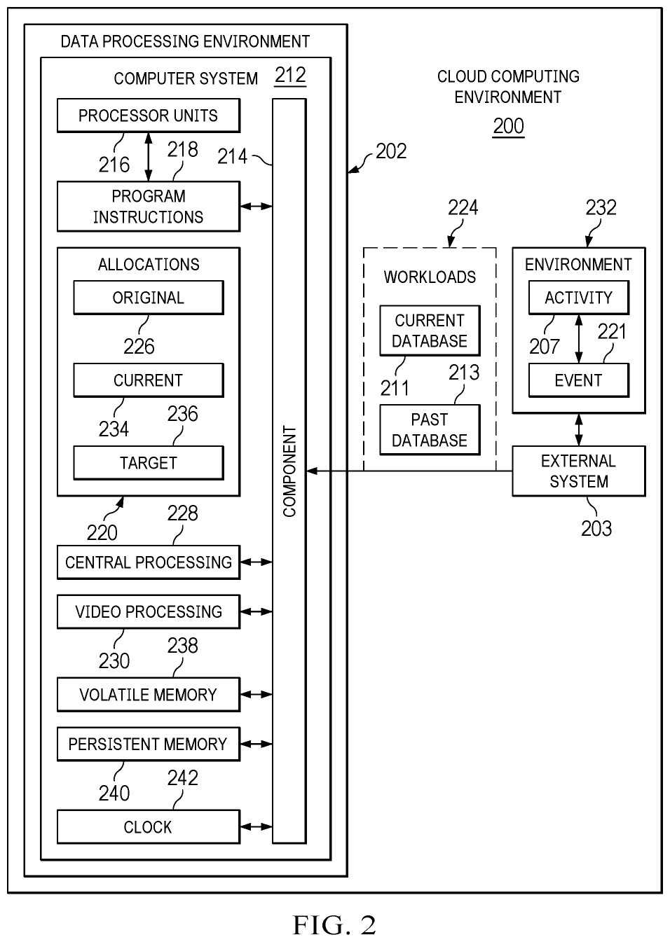

With reference now to FIG. 2, a block diagram of a cloud computing environment is depicted in accordance with an illustrative embodiment. In this illustrative example, cloud computing environment 200 includes components that can be implemented in hardware such as the hardware shown in computing environment 100 in FIG. 1.

Data processing environment 202 is located in cloud computing environment 200. Data processing environment 202 includes computer system 212. External stream 203 is coupled to computer system 212 and can provide external data. External stream 203 can convey environment data 232. Environmental data 232 can include activity data 207 and event data 221. External stream 203 can convey workloads data 224. Workloads data 224 can include current database data 211 and/or past database data 213. Computer system 212 includes component 214.

Component 214 may be termed a determiner and/or switcher because component 214 implements a number of these functions such as one, or both of these functions. In particular, component 214 may be deployed and/or implemented using block 190 in FIG. 1.

Component 214 can be implemented in software, hardware, firmware or a combination thereof. When software is used, the operations performed by component 214 can be implemented in program instructions configured to run on hardware, such as a processor unit. When firmware is used, the operations performed by component 214 can be implemented in program instructions and data and stored in persistent memory to run on a processor unit. When hardware is employed, the hardware can include circuits that operate to perform the operations in component 214.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of parameters” is one or more parameters. As another example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes such as in the illustrative examples. In other words, program instructions 218 are computer readable program instructions.

As used herein, a processor unit in the number of processor units 216 is a hardware device and is comprised of hardware circuits such as those on an integrated circuit that respond to and process instructions and program code that operate a computer. A processor unit can be implemented using processor set 110 in FIG. 1. When the number of processor units 216 executes program instructions 218 for a process, the number of processor units 216 can be one or more processor units that are in the same computer or in different computers. In other words, the process can be distributed between processor units 216 on the same or different computers in computer system 212.

Further, the number of processor units 216 can be of the same type or different types of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

Computer system 212 can be configured to perform at least one of the steps, operations, or actions described in the different illustrative examples using software, hardware, firmware or a combination thereof. As a result, computer system 212 operates as a special purpose computer system in which component 214 in computer system 212 enables determining a fixed percentage per increment by which to alter a current allocation of at least one of a set of compute resources allocated to at least one of a set of workloads in the cloud computing environment during a selected period of time to incrementally switch the current allocation of the at least one of the set of compute resources allocated to the at least one of the set of workloads in the cloud computing environment from an original allocation to a target allocation; and switching incrementally by the fixed percentage per increment the current allocation from the original allocation to the target allocation during the selected period of time. In particular, component 214 transforms computer system 212 into a special purpose computer system as compared to currently available general computer systems that do not have component 214.

In the illustrative example, the use of component 214 in computer system 212 integrates processes into a practical application for determining, by a number of processors, a fixed percentage per increment by which to alter a current allocation of at least one of a set of compute resources allocated to at least one of a set of workloads in the cloud computing environment during a selected period of time to incrementally switch the current allocation of the at least one of the set of compute resources allocated to the at least one of the set of workloads in the cloud computing environment from an original allocation to a target allocation; and switching, by the number of processors, incrementally by the fixed percentage per increment the current allocation from the original allocation to the target allocation during the selected period of time that increases the performance of computer system 212. In other words, component 214 in computer system 212 is directed to a practical application of processes integrated into component 214 in computer system 212 that controls incremental re-allocating of computer resources. In this illustrative example, component 214 in computer system 212 can also control the incremental re-allocation of computer resources. In this manner, component 214 in computer system 212 provides a practical application of incrementally re-allocating computer resources such that the functioning of computer system 212 and transportation vehicle 202 are improved.

Data processing environment 202 includes allocations 220. Allocations 220 can include original allocations 226. Allocations 220 can include current allocations 234. Allocations 220 can include target allocations 236.

Computer system 212 can include primary central processing resources 228. Computer system 212 can include video processing resources 230. Computer system 212 can include volatile memory resources 238. Computer system 212 can include persistent memory resources 240. Computer system 212 can include clock 242. Clock 242 can be used to perform switching of resources at substantially constant time intervals and/or at uneven time intervals.

The illustration of the computer system and its data processing environment in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

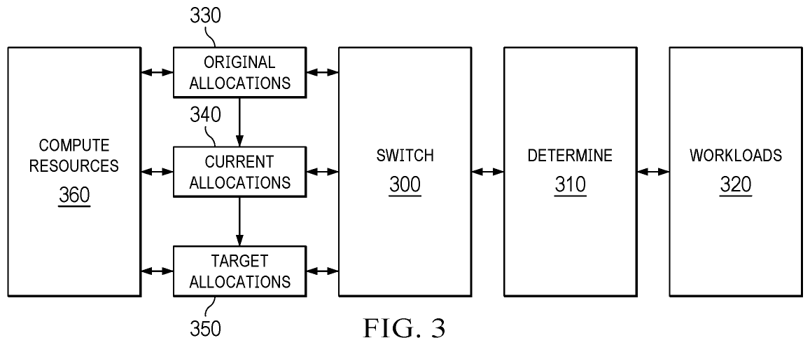

Turning next to FIG. 3, a dataflow diagram of embodiments of this disclosure is depicted. Block 300 can be termed switch and interacts with block 310. The data in block 310 can be termed determiner and interacts with block 320. The data in block 320 can be termed workloads. The data in block 300 interacts with block 330, block 340, and block 350. The data in block 330 can be termed original allocation. The data in block 340 can be termed current allocation. The data in block 350 can be termed target allocations. Block 360 interacts with block 330, block 340, and block 350. The data in block 360 can be termed computer resources.

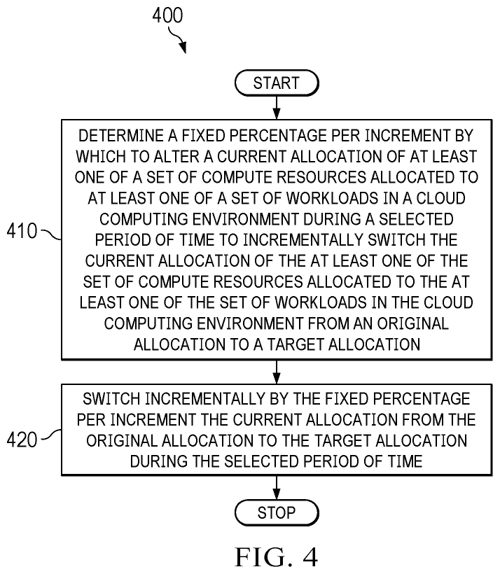

Turning next to FIG. 4, a flowchart of a process 400 is depicted to determine a fixed percentage per increment by which to alter a current allocation of at least one of a set of compute resources allocated to at least one of a set of workloads in a cloud computing environment during a selected period of time to incrementally switch the current allocation of the at least one of the set of compute resources allocated to the at least one of the set of workloads in the cloud computing environment from an original allocation to a target allocation; and switch incrementally by the fixed percentage per increment the current allocation from the original allocation to the target allocation during the selected period of time in accordance with an illustrative embodiment. The process in FIG. 4 can be implemented in hardware, software, or both. When implemented in software, the process can take the form of program instructions that are run by one of more processor units located in one or more hardware devices in one or more computer systems. For example, the process of FIG. 4 can be implemented in component 214 in computer system 212 in FIG. 2.

Block 410 determines a fixed percentage per increment by which to alter a current allocation of at least one of a set of compute resources allocated to at least one of a set of workloads in a cloud computing environment during a selected period of time to incrementally switch the current allocation of the at least one of the set of compute resources allocated to the at least one of the set of workloads in the cloud computing environment from an original allocation to a target allocation. Block 420 switches incrementally by the fixed percentage per increment the current allocation from the original allocation to the target allocation during the selected period of time.

Embodiments of this disclosure use a calculation to alter resource allocations by a fixed percentage incrementally over an arbitrary period of time. The method assumes that there is a current resource limit and a target resource limit that the system should move to over a period of time.

For example, new_alloc=original_alloc*e\hat{ }rt

We can say that t=0 is the start of our rollout period and at t=1, we want to have reached our target resource allocation. The rollout duration can be any amount of time the administrator decides on. The value of “t” is just the ratio of how much time has passed to the overall rollout duration. For example, 2 days into a rollout duration of 5 days would give a value of t=0.4. Since we know our original resource allocation at t=0 and we know the target resource allocation at t=1, we can solve for “r”. This will give us a constant percentage change in order to ensure a smooth percentage change in the computer resources over the rollout duration.

target_alloc=original_alloc*e\hat{ }r

ln(target_alloc)=ln(original_alloc*e\hat{ }r)

ln(target_alloc)=ln(original_alloc)+ln(e\hat{ }r)

ln(target_alloc)=ln(original_alloc)+r

r=ln(target_alloc)−ln(original_alloc)

Using this fixed value for ‘r’, we can compute the appropriate resource allocation at any point in time during the rolloutwindow:

new_alloc=original_alloc*e\hat{ }rt

The following is an example comparing the linear approach vs. the constant percentage approach.

Linear CPU reduction from 16 cores to 1 core over 15 days:
Day 0: 16 cores
Day 1: 15 cores (6.25% reduction)
Day 2: 14 cores (6.67% reduction)
Day 3: 13 cores (7.14% reduction)
Day 4: 12 cores (7.69% reduction)
Day 5: 11 cores (8.33% reduction)
Day 6: 10 cores (9.09% reduction)
Day 7: 9 cores (10% reduction)
Day 8: 8 cores (11.11% reduction)
Day 9: 7 cores (12.5% reduction)
Day 10: 6 cores (14.29% reduction)
Day 11: 5 cores (16.67% reduction)
Day 12: 4 cores (20% reduction)
Day 13: 3 cores (25% reduction)
Day 14: 2 cores (33.33% reduction)
Day 15: 1 core (50% reduction)

In contrast to the above, the following is the constant percentage reduction from 16 cores to 1 core over 15 days based on r=ln 1−In 16=−2.7725887
Day 0 (t=0): 16 cores
Day 1 (t=1/15): 13.30 cores (16.88% reduction)
Day 2 (t=2/15): 11.06 cores (16.88% reduction)
Day 3 (t=3/15): 9.19 cores (16.88% reduction)
Day 4 (t=4/15): 7.64 cores (16.88% reduction)
Day 5 (t=5/15): 6.35 cores (16.88% reduction)
Day 6 (t=6/15): 5.28 cores (16.88% reduction)
Day 7 (t=7/15): 4.39 cores (16.88% reduction)
Day 8 (t=8/15): 3.65 cores (16.88% reduction)
Day 9 (t=9/15): 3.03 cores (16.88% reduction)
Day 10 (t=10/15): 2.52 cores (16.88% reduction)
Day 11 (t=11/15): 2.09 cores (16.88% reduction)
Day 12 (t=12/15): 1.74 cores (16.88% reduction)
Day 13 (t=13/15): 1.45 cores (16.88% reduction)
Day 14 (t=14/15): 1.20 cores (16.88% reduction)
Day 15 (t=1): 1 core (16.88% reduction)

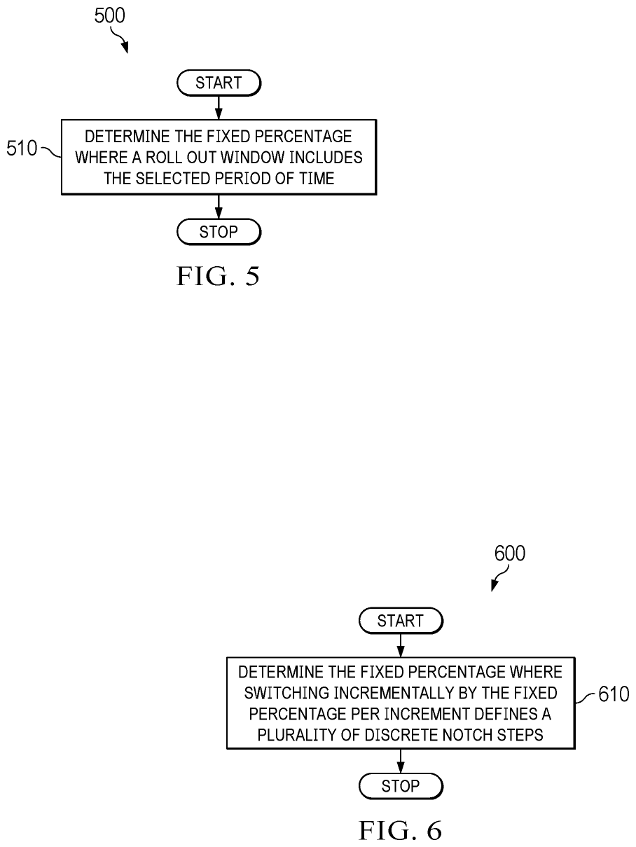

Turning now to FIG. 5, a flowchart of a process 500 to determine a fixed percentage per increment by which to alter a current allocation of at least one of a set of compute resources allocated to at least one of a set of workloads in a cloud computing environment during a selected period of time to incrementally switch the current allocation of the at least one of the set of compute resources allocated to the at least one of the set of workloads in the cloud computing environment from an original allocation to a target allocation, wherein a roll out window comprises the selected period of time is depicted in accordance with an illustrative embodiment. The process in FIG. 5 can be implemented in hardware, software, or both. When implemented in software, this process can take the form of program instructions that are run by one of more processor units located in one or more hardware devices in one or more computer systems. For example, the process of FIG. 5 can be implemented in component 214 in computer system 212 in FIG. 2. Block 510 determines a fixed percentage per increment by which to alter a current allocation of at least one of a set of compute resources allocated to at least one of a set of workloads in a cloud computing environment during a selected period of time to incrementally switch the current allocation of the at least one of the set of compute resources allocated to the at least one of the set of workloads in the cloud computing environment from an original allocation to a target allocation during a roll out window that includes the selected period of time.

Turning now to FIG. 6, a flowchart of a process 600 to determine a fixed percentage per increment by which to alter a current allocation of at least one of a set of compute resources allocated to at least one of a set of workloads in a cloud computing environment during a selected period of time to incrementally switch the current allocation of the at least one of the set of compute resources allocated to the at least one of the set of workloads in the cloud computing environment from an original allocation to a target allocation, wherein switching incrementally by the fixed percentage per increment defines a plurality of discrete notch steps is depicted in accordance with an illustrative embodiment. The process in FIG. 6 can be implemented in hardware, software, or both. When implemented in software, this process can take the form of program instructions that are run by one of more processor units located in one or more hardware devices in one or more computer systems. For example, the process of FIG. 6 can be implemented in component 214 in computer system 212 in FIG. 2. Block 610 determines a fixed percentage per increment by which to alter a current allocation of at least one of a set of compute resources allocated to at least one of a set of workloads in a cloud computing environment during a selected period of time to incrementally switch the current allocation of the at least one of the set of compute resources allocated to the at least one of the set of workloads in the cloud computing environment from an original allocation to a target allocation defining a plurality of discrete notch steps.

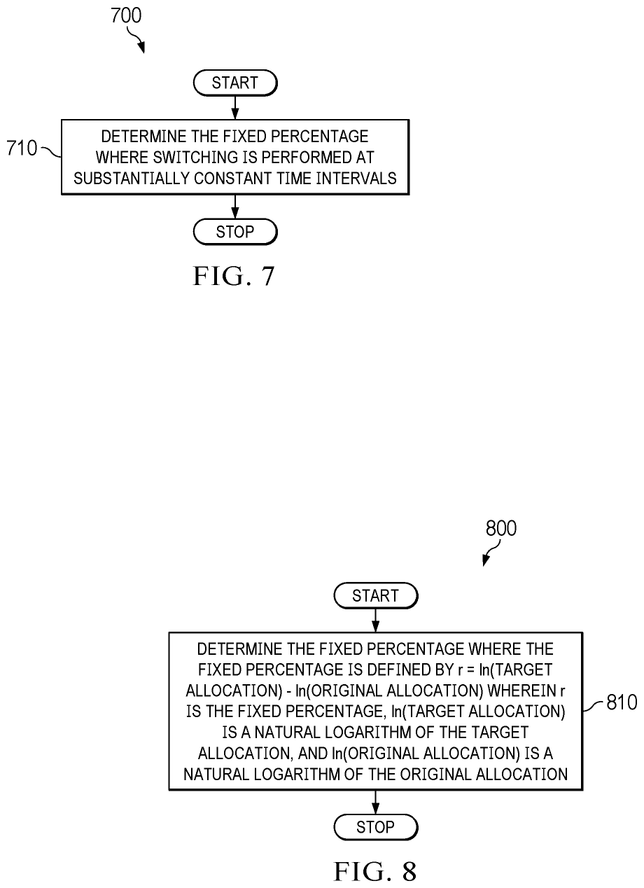

Turning now to FIG. 7, a flowchart of a process 700 to determine a fixed percentage per increment by which to alter a current allocation of at least one of a set of compute resources allocated to at least one of a set of workloads in a cloud computing environment during a selected period of time to incrementally switch the current allocation of the at least one of the set of compute resources allocated to the at least one of the set of workloads in the cloud computing environment from an original allocation to a target allocation, wherein switching is performed at substantially constant time intervals is depicted in accordance with an illustrative embodiment. The process in FIG. 7 can be implemented in hardware, software, or both. When implemented in software, this process can take the form of program instructions that are run by one of more processor units located in one or more hardware devices in one or more computer systems. For example, the process of FIG. 7 can be implemented in component 214 in computer system 212 in FIG. 2. Block 710 determines a fixed percentage per increment by which to alter a current allocation of at least one of a set of compute resources allocated to at least one of a set of workloads in a cloud computing environment during a selected period of time to incrementally switch the current allocation of the at least one of the set of compute resources allocated to the at least one of the set of workloads in the cloud computing environment from an original allocation to a target allocation performed at substantially constant time intervals. In alternative embodiments, switching can be performed at uneven time intervals.

Turning now to FIG. 8, a flowchart of a process 800 to determine a fixed percentage per increment by which to alter a current allocation of at least one of a set of compute resources allocated to at least one of a set of workloads in a cloud computing environment during a selected period of time to incrementally switch the current allocation of the at least one of the set of compute resources allocated to the at least one of the set of workloads in the cloud computing environment from an original allocation to a target allocation, wherein the fixed percentage is defined by r=ln(target allocation) −ln(original allocation) wherein r is the fixed percentage, ln(target allocation) is a natural logarithm of the target allocation, and ln(original allocation) is a natural logarithm of the original allocation is depicted in accordance with an illustrative embodiment. The process in FIG. 8 can be implemented in hardware, software, or both. When implemented in software, this process can take the form of program instructions that are run by one of more processor units located in one or more hardware devices in one or more computer systems. For example, the process of FIG. 8 can be implemented in component 214 in computer system 212 in FIG. 2. Block 810 determines a fixed percentage per increment by which to alter a current allocation of at least one of a set of compute resources allocated to at least one of a set of workloads in a cloud computing environment during a selected period of time to incrementally switch the current allocation of the at least one of the set of compute resources allocated to the at least one of the set of workloads in the cloud computing environment from an original allocation to a target allocation, where the fixed percentage is defined by r=ln(target allocation) −ln(original allocation) wherein r is the fixed percentage, ln(target allocation) is a natural logarithm of the target allocation, and ln(original allocation) is a natural logarithm of the original allocation.

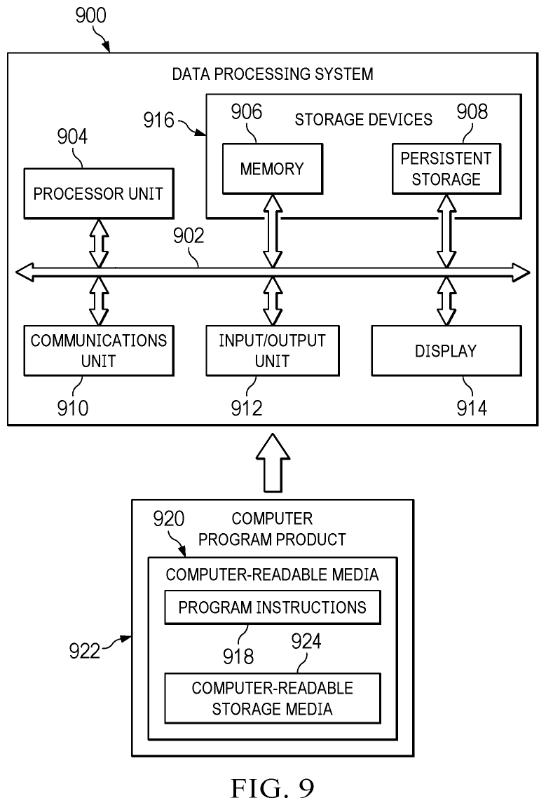

Turning now to FIG. 9, a block diagram of a data processing system is depicted in accordance with an illustrative embodiment. Data processing system 900 can be used to implement computers and computing devices in computing environment 100 in FIG. 1. Data processing system 900 can also be used to implement computer system 212 in FIG. 2. In this illustrative example, data processing system 900 includes communications framework 902, which provides communications between processor unit 904, memory 906, persistent storage 908, communications unit 910, input/output (I/O) unit 912, and display 914. In this example, communications framework 902 takes the form of a bus system.

Processor unit 904 serves to execute instructions for software that can be loaded into memory 906. Processor unit 904 includes one or more processors. For example, processor unit 904 can be selected from at least one of a multicore processor, a central processing unit (CPU), a graphics processing unit (GPU), a physics processing unit (PPU), a digital signal processor (DSP), a network processor, or some other suitable type of processor. Further, processor unit 904 can be implemented using one or more heterogeneous processor systems in which a main processor is present with secondary processors on a single chip. As another illustrative example, processor unit 904 can be a symmetric multi-processor system containing multiple processors of the same type on a single chip.

Memory 906 and persistent storage 908 are examples of storage devices 916. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 916 may also be referred to as computer readable storage devices in these illustrative examples. Memory 906, in these examples, can be, for example, a random-access memory or any other suitable volatile or non-volatile storage device. Persistent storage 908 may take various forms, depending on the particular implementation.

For example, persistent storage 908 may contain one or more components or devices. For example, persistent storage 908 can be a hard drive, a solid-state drive (SSD), a flash memory, a rewritable optical disk, a rewritable magnetic tape, or some combination of the above. The media used by persistent storage 908 also can be removable. For example, a removable hard drive can be used for persistent storage 908.

Communications unit 910, in these illustrative examples, provides for communications with other data processing systems or devices. In these illustrative examples, communications unit 910 is a network interface card.

Input/output unit 912 allows for input and output of data with other devices that can be connected to data processing system 900. For example, input/output unit 912 may provide a connection for user input through at least one of a keyboard, a mouse, or some other suitable input device. Further, input/output unit 912 may send output to a printer. Display 914 provides a mechanism to display information to a user.

Instructions for at least one of the operating system, applications, or programs can be located in storage devices 916, which are in communication with processor unit 904 through communications framework 902. The processes of the different embodiments can be performed by processor unit 904 using computer-implemented instructions, which may be located in a memory, such as memory 906.

These instructions are referred to as program instructions, computer usable program instructions, or computer readable program instructions that can be read and executed by a processor in processor unit 904. The program instructions in the different embodiments can be embodied on different physical or computer readable storage media, such as memory 906 or persistent storage 908.

Program instructions 918 are located in a functional form on computer readable media 920 that is selectively removable and can be loaded onto or transferred to data processing system 900 for execution by processor unit 904. Program instructions 918 and computer readable media 920 form computer program product 922 in these illustrative examples. In the illustrative example, computer readable media 920 is computer readable storage media 924.

Computer readable storage media 924 is a physical or tangible storage device used to store program instructions 918 rather than a medium that propagates or transmits program instructions 918. Computer readable storage media 924, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 918 can be transferred to data processing system 900 using a computer readable signal media. The computer readable signal media are signals and can be, for example, a propagated data signal containing program instructions 918. For example, the computer readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer readable media 920 can be singular or plural. For example, program instructions 918 can be located in computer readable media 920 in the form of a single storage device or system. In another example, program instructions 918 can be located in computer readable media 920 that is distributed in multiple data processing systems. In other words, some instructions in program instructions 918 can be located in one data processing system while other instructions in program instructions 918 can be located in one data processing system. For example, a portion of program instructions 918 can be located in computer readable media 920 in a server computer while another portion of program instructions 918 can be located in computer readable media 920 located in a set of client computers.

The different components illustrated for data processing system 900 are not meant to provide architectural limitations to the manner in which different embodiments can be implemented. In some illustrative examples, one or more of the components may be incorporated in or otherwise form a portion of, another component. For example, memory 906, or portions thereof, may be incorporated in processor unit 904 in some illustrative examples. The different illustrative embodiments can be implemented in a data processing system including components in addition to or in place of those illustrated for data processing system 900. Other components shown in FIG. 9 can be varied from the illustrative examples shown. The different embodiments can be implemented using any hardware device or system capable of running program instructions 918.

Thus, illustrative embodiments of the present invention provide a computer implemented method, computer system, and computer program product for predicting, using an artificial intelligence enabled system, an incremental degradation of a battery of a transportation vehicle based on a selected route, historical learning about battery degradation parameters, and a current condition of the battery of the transportation vehicle; calculating an equivalent carbon footprint tax based on the incremental degradation of the battery of the transportation vehicle; and assessing the equivalent carbon footprint tax against the transportation vehicle.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for gradually altering compute resources allocated to workloads in a cloud computing environment, comprising:
determining, by a number of processors, a fixed percentage per increment by which to alter a current allocation of at least one of a set of compute resources allocated to at least one of a set of workloads in the cloud computing environment during a selected period of time to incrementally switch the current allocation of the at least one of the set of compute resources allocated to the at least one of the set of workloads in the cloud computing environment from an original allocation to a target allocation; and
switching, by the number of processors, incrementally by the fixed percentage per increment the current allocation from the original allocation to the target allocation during the selected period of time.

2. The computer implemented method of claim 1, wherein the set of compute resources comprises at least one of central processing units, volatile memory, and persistent memory.

3. The computer implemented method of claim 1, wherein a roll out window comprises the selected period of time.

4. The computer implemented method of claim 1, wherein switching incrementally by the fixed percentage per increment defines a plurality of discrete notch steps.

5. The computer implemented method of claim 1, wherein switching is performed at substantially constant time intervals.

6. The computer implemented method of claim 1, wherein switching is performed at uneven time intervals.

7. The computer implemented method of claim 1, wherein the fixed percentage is defined by
r=ln(target allocation)−ln(original allocation)
wherein r is the fixed percentage, ln(target allocation) is a natural logarithm of the target allocation, and ln(original allocation) is a natural logarithm of the original allocation.

8. A computer system comprising:
a number of processor units, wherein the number of processor units executes program instructions to:
determine, by a number of processors, a fixed percentage per increment by which to alter a current allocation of at least one of a set of compute resources allocated to at least one of a set of workloads in a cloud computing environment during a selected period of time to incrementally switch the current allocation of the at least one of the set of compute resources allocated to the at least one of the set of workloads in the cloud computing environment from an original allocation to a target allocation; and
switch, by the number of processors, incrementally by the fixed percentage per increment the current allocation from the original allocation to the target allocation during the selected period of time.

9. The computer system of claim 8, wherein the set of compute resources comprises at least one of central processing units, volatile memory, and persistent memory.

10. The computer system of claim 8, wherein a roll out window comprises the selected period of time.

11. The computer system of claim 8, wherein switching incrementally by the fixed percentage per increment defines a plurality of discrete notch steps.

12. The computer system of claim 8, wherein switching is performed at substantially constant time intervals.

13. The computer system of claim 8, wherein switching is performed at uneven time intervals.

14. The computer system of claim 8, wherein the fixed percentage is defined by
r=ln(target allocation)−ln(original allocation)
wherein r is the fixed percentage, ln(target allocation) is a natural logarithm of the target allocation, and ln(original allocation) is a natural logarithm of the original allocation.

15. A computer program product comprising
a computer readable storage medium having program instructions embodied therewith, the program instructions executable by a computer system to cause the computer system to:
determine, by a number of processors, a fixed percentage per increment by which to alter a current allocation of at least one of a set of compute resources allocated to at least one of a set of workloads in a cloud computing environment during a selected period of time to incrementally switch the current allocation of the at least one of the set of compute resources allocated to the at least one of the set of workloads in the cloud computing environment from an original allocation to a target allocation; and
switch, by the number of processors, incrementally by the fixed percentage per increment the current allocation from the original allocation to the target allocation during the selected period of time.

16. The computer program product of claim 15, wherein the program instructions are further executable by the computer system to cause the computer system to: determine, wherein a roll out window comprises the selected period of time.

17. The computer program product of claim 15, wherein the program instructions are further executable by the computer system to cause the computer system to: determine, wherein switching incrementally by the fixed percentage per increment defines a plurality of discrete notch steps.

18. The computer program product of claim 15, wherein the program instructions are further executable by the computer system to cause the computer system to: determine, wherein switching is performed at substantially constant time intervals.

19. The computer program product of claim 15, wherein the program instructions are further executable by the computer system to cause the computer system to: determine, wherein switching is performed at uneven time intervals.

20. The computer program product of claim 15, wherein the program instructions are further executable by the computer system to cause the computer system to: determine, wherein the fixed percentage is defined by
r=ln(target allocation)−ln(original allocation)
wherein r is the fixed percentage, ln(target allocation) is a natural logarithm of the target allocation, and ln(original allocation) is a natural logarithm of the original allocation.
